(19) United States
(12) Patent Application Publication
(10) Pub. No.: US 2015/0093835 A1
(43) Pub. Date: Apr. 2, 2015

(54) COATED AND FUNCTIONALIZED PARTICLES, POLYMER CONTAINING SAME, METHOD FOR PREPARING SAME AND USES THEREOF

(71) Applicant: COMMISSARIAT A L'ENERGIE ATOMIQUE ET AUX ENERGIES ALTERNATIVES, Paris (FR)

(72) Inventors: Olivier Raccurt, Chelieu (FR); Jorice Samuel, Vizille (FR)

(21) Appl. No.: 14/553,063

(22) Filed: Nov. 25, 2014

Related U.S. Application Data
(62) Division of application No. 12/863,971, filed on Jan. 11, 2011.

(30) Foreign Application Priority Data
Jan. 22, 2008 (FR) 08 50378

(51) Int. Cl. C09K 11/02; G01N 21/64

(52) U.S. Cl. CPC C09K 11/025; G01N 21/6489
USPC 436/56

(57) ABSTRACT

The present invention relates to a particle comprising a core which comprises an oxide selected from rare earth oxides alone or in a mixture with metal oxides and which is coated with a layer of silica functionalized with a coupling agent comprising at least one chemical function soluble in a hydrophobic solvent, and to a composition comprising at least one such particle. The present invention likewise relates to the method for preparing same and to various uses thereof.

### TECHNICAL FIELD

The present invention pertains to the field of coated and functionalized particles and also to the compositions comprising them, such as polymers, and especially thermosetting polymers.

The present invention likewise pertains to a method for preparing these particles and these compositions, and to their various uses, especially for improving the physicochemical properties of polymers.

### BACKGROUND ART

There are already a certain number of products and methods in existence that aim effectively to combat the counterfeiting of manufactured articles and particularly of textile articles. These products and methods include visual marks such as holograms or magnetic marks. The present invention is aimed at supplying new marking methods and products which on the one hand do not require the articles to be unwrapped and which on the other hand can be employed when the article is already in use, with its labels and/or packaging removed. Indeed, the coated and functionalized oxide particles which are a subject of the present invention can be introduced into a polymer intended for coating onto fabrics or other substrates, and provide homogeneous marking of different types of substrates for a variety of applications, including anticounterfeit marking, using the properties of luminescence, for example, of these particles. These particles may also be incorporated directly into the substance of the material to be marked.

The incorporation of nanometer-sized or micrometer-sized particles into polymers has already been explored. Such incorporation makes it possible in particular to improve the mechanical strength of the polymers. Indeed, Wetzel et al. (2003) propose the incorporation of particles into epoxy resins, and Chen et al. (2007) suggest incorporating functionalized silica particles into a polyurethane-based acrylic polymer. However, in order to be effective, such incorporation must be homogeneous, and this is not always the case (see Oberdisse, 2006). Magnetic or luminescent particles have also been incorporated into various polymers. Goubard et al. (2007), for example, have demonstrated the incorporation of luminescent particles based on lanthanide oxide into PEO for optical properties. The innovation here lies in the homogeneous incorporation of particles into hydrophobic-based polymers, through a dual surface treatment of the particles.

The functionalization of silica particles is known in the art. The technique commonly employed for such functionalization involves utilizing the surface reactivity of the silica to react the Si-OH groups of the surface oxide with the chlorosilane function of the molecule to be grafted. The other end of the molecule to be grafted contains a chemical function which is compatible with the solvent in question. Suggested molecules for grafting are, for example, the following: APTES (3-aminopropyltriethoxysilane), FDTS (1H,1H,2H,2H-perfluorodecyltrichlorosilane), and OTS (octadecyltrichlorosilane) (Bagwe et al., 2004). Likewise proposed are various methods of coating the silica with monomers, which, by polymerization at the surface of the particles, produce a homogeneous dispersion of these particles in various polymers. Chen et al. (2005) show an example of surface polymerization of polyurethane with nanoparticles of silica that have been coated beforehand with APTES. Chalaye et al. (2001) suggest the encapsulation of the silica with a coupling agent to form latex nanocomposites. Feng et al. (2005) describe how SiO₂/TiO₂ nanocomposites can be encapsulated with a given polymer, which is polyurethane. Similarly, the works of Iijima et al. (2007) suggest the covalent grafting of a hexyltrimethoxysilane molecule onto silica nanoparticles in order to facilitate coupling with methyl ethyl ketone (MEK). Patent application US 2007/0104860 and international application WO 2007/068859 describe, respectively, the coating of various types of nanometer-sized particles with vinyl-based polymers by a method derived from chemical vapor deposition, and the coating of inorganic particles with an organic polymer by a micelle route.

International application WO 2005/037470 presents the encapsulation of nanoparticles of different types, and particularly of metal oxide, with organic compounds based on polyester resin, on which there will subsequently be grafted a stabilizing agent based on polyhydroxyl compounds, for textile (primarily mechanical) applications.

From a chemical standpoint, however, the growth of a layer or the coating with a polymer of an oxide particle other than silica may prove to be extremely difficult, particularly so on crystalline oxides. Consequently there exists a real need to overcome this difficulty if the aim is to obtain homogeneous incorporation of these particles into different polymers, for optical applications in particular.

The coating of nanoparticles with silica, followed by their functionalization by grafting of chemical functions, is already known in the very remote field of biology, and more particularly in the field of tracers for biology. However, it must be specified in this regard that the grafted surface function is required to have a number of features which make the nanoparticle biocompatible, one of these being that it must be hydrophilic. Louis et al. (2005), for example, propose a coating of luminescent rare-earth-oxide-based nanoparticles with silica, followed by functionalization by means of the chemical function APTES, which is a hydrophilic amine function. These nanoparticles will therefore be dispersible in aqueous medium. Conversely, one of the technical problems that the present invention aims to solve is dispersion in hydrophobic medium, which is never an aim of the biologists.

### DESCRIPTION OF THE INVENTION

The products and methods which are subject matter of the present invention allow the aforementioned technical problems to be solved. Indeed, the subject matter of the invention relates to a method which allows particles other than silica to be incorporated and dispersed in a polymer such as a thermosetting polymer (resin) by the application of a particle surface treatment that breaks down into two phases: coating of the particle with a layer of silica, then surface functionalization by a coupling agent which attaches to the silica surface by covalent bonding and comprises at least one chemical function having a high affinity with the polymer and/or the solvent of the polymer in which the particles are dispersed.

The present invention is notable in that the coated and functionalized particles can be used when dispersed in a varnish to be coated onto a material or into the substance of a polymer that forms a manufactured object, for combating the counterfeiting not only of fabrics but also of many other articles. Moreover, these particles may also be used for various other applications described hereinafter.

Accordingly, the present invention relates first of all to a particle comprising a core coated with a layer of silica functionalized with a coupling agent comprising at least one chemical function soluble in a hydrophobic solvent. Such a particle is referred to in the present text as a coated and functionalized particle.

By “coated” is meant, in the context of the present invention, that the silica layer is present on some or all of the surface of the core. Advantageously, the core of the particle is entirely coated with the silica layer.

By “functionalized” is meant, in the context of the present invention, that the functional properties of the silica layer are modified by the bonding of the coupling agent, which makes it possible, in particular, to increase the affinity of the silica layer for hydrophobic media and, consequently, the solubility of the coated and functionalized particle in hydrophobic media.

In a first variant, the core of the particle which is the subject matter of the present invention is composed of oxide and, more particularly, of an oxide selected from metal oxides, rare earth oxides, and mixtures thereof. The core of the particle which is the subject matter of the present invention advantageously comprises an oxide selected from rare earth oxides alone or in a mixture with metal oxides. The core of the particle which is the subject matter of the present invention exhibits luminescent properties and is essentially composed of rare earth oxides. More particularly, the core of the particle which is the subject matter of the present invention is composed of an oxide selected from rare earth oxides alone or in a mixture with metal oxides.

Rare earth oxides are particularly the oxides of lanthanides, such as the oxides of lanthanum, cerium, praseodymium, neodymium, promethium, samarium, europium, gadolinium, terbium, dysprosium, holmium, erbium, thulium, ytterbium, lutetium, oxides of yttrium, oxides of scandium, and mixtures thereof. More particularly, the preferred rare earth oxides are selected from oxides of lanthanum, praseodymium, neodymium, yttrium, gadolinium, and mixtures thereof.

The core of the particle which is the subject matter of the present invention may be composed, comprise or include other compounds based on rare earths, such as, for example, yttrium aluminum garnet (YAG), yttrium aluminum oxide (YAlO) or vanadated yttrium oxide, alone or in a mixture with rare earth oxides as defined in the present text.

Any metal oxide can be used in the context of the present invention. The metal oxides more particularly employed in the context of the present invention are selected from oxides of aluminum, of antimony, of tin, of iron, of indium, of titanium, of zinc, and mixtures thereof.

The rare earth oxides, the metal oxides, and mixtures thereof may in particular be present in wholly or partly doped form. The skilled person is aware, without any inventive effort, of how to prepare metal oxides or rare earth oxides in doped form. Doping may take place, for example, via the intermediacy of europium.

In a second variant, the core of the particle which is the subject matter of the present invention is composed of an organic compound. Any organic compound can be used in the context of the present invention. Advantageously, the core of the particle which is the subject matter of the present invention is composed of an organic compound selected from thermoplastic and/or thermosetting polymers or copolymers and/or biopolymers.

As examples, the thermoplastic polymers or copolymers which can be employed in the context of the present invention belong to the classes of the polyolefins, polyvinyl, polyvinylidene, polystyrene, and acrylic/methacrylic polymers, polyamides, polyesters, polyethers, poly(arylenesulfones), polysulfides, polyfluoropolymers, cellulosic polymers, poly(aryletherketones), polyimides, and polyetherimides.

The thermosetting polymers which can be employed in the context of the present invention to form the core of the coated and functionalized particles are thermosetting polymers, which will be defined hereinbelow.

A final addition to these lists are biopolymers, such as microbial biopolymers (polyhydroxyalkanoates and derivatives), biopolymers obtained from plants (for example, latex, starch, cellulose, lignin, and derivatives), and biopolymers obtained from the chemical polymerization of biological entities (polylactic polymers).

The organic core of the coated and functionalized particles according to the invention may also be composed of copolymers containing the monomeric units based on the polymers above, such as, for example, poly(vinylidene chloride)-co-poly(vinyl chloride) or else poly(styrene/acrylonitrile) copolymers.

In a third variant of the present invention, the core of the particle which is the subject matter of the present invention is composed of a metal and, more particularly, of a metal selected from silver, aluminum, copper, gold, and mixtures thereof.

The particles employed in the context of the present invention may be of any shape and any size. Indeed, these particles may be spherical in form or may equally well have any desired form, and may have a monodisperse or polydisperse size distribution. Advantageously, the particles employed in the present invention are particles of nanometer to micrometer size. Accordingly, these particles have characteristic dimensions of between 1 nm and 200 μm, in particular between 2 nm and 30 μm, and, more precisely, between 2 nm and 1 μm.

In the context of the present invention, a “coupling agent”, also called “bonding agent”, is a chemical group or compound capable of ensuring coupling (i.e., bonding) between the silica layer of the particle and the hydrophobic solvent or the hydrophobic polymers, while facilitating the dispersion of this particle within said solvent or said polymers. Hence the coupling agent employed in the context of the present invention has a chemical function capable of interacting with the silica layer, and has a chemical function capable of interacting with a hydrophobic solvent. The first function makes it possible, advantageously, for a covalent bond to be formed between the silica layer and the coupling agent. The second function, in its turn, corresponds to the chemical function soluble in a hydrophobic solvent.

By “chemical function soluble in a hydrophobic solvent” is meant, in the context of the present invention, a nonpolar or apolar chemical function which is completely dissolved in a concentration greater than or equal to 5% by weight and at ambient temperature in a hydrophobic solvent. Said chemical function advantageously contains from 6 to 50 carbon atoms, in particular from 6 to 30 carbon atoms, and more particularly from 10 to 20 carbon atoms. Said chemical function is more particularly selected from the group consisting of
C6 to C50, in particular C6 to C30, and more particularly C10 to C20 linear or branched alkyls possibly containing optionally at least one unsaturation and/or at least one heteroatom,
C6 to C50, in particular C6 to C30, and more particularly C10 to C20 alkylaryls or arylalkyls possibly containing optionally at least one unsaturation and/or at least one heteroatom, and
C6 to C50, in particular C6 to C30, and more particularly C10 to C20 (poly)cyclics possibly containing optionally at least one unsaturation and/or at least one heteroatom.

The coupling agent employed in the context of the present invention is advantageously a silane-derived compound having a chemical function soluble in a hydrophobic solvent. A silane derivative of this kind which is more particularly employed in the present invention as a coupling agent is hexadecyl-trimethoxysilane. Accordingly, the present invention relates to the use of hexadecyltrimethoxysilane as a coupling agent intended for grafting on a silica-coated particle.

The present invention also relates to a composition comprising at least one coated and functionalized particle as defined above in a hydrophobic or partially hydrophobic solvent.

By “hydrophobic solvent” is meant, in the context of the present invention, a solvent which is substantially insoluble in water. As examples, and nonexhaustively, the hydrophobic solvent employed in the context of the present invention is selected from aromatic solvents such as toluenes, xylenes, alkylbenzenes, and alkylnaphthalenes; saturated and unsaturated hydrocarbons, aryl alkyl ketones such as methyl ethyl ketone, esters, fatty acid methyl esters, C1 to C6 alkyl esters, such as methyl ester and ethyl ester, esters of acetic acid or benzoic acid, amides of alkanecarboxylic acids, linear or cyclic acetates, alkylpyrrolidones, alkylcaprolactones, alkyl carbonates, chloroform, and mixtures thereof.

By “partially hydrophobic solvent” is meant, in the context of the present invention, a solvent which is partially soluble in water, i.e., a solvent whose solubility in water, expressed as a percentage by volume, is at least 10%. A partially hydrophobic solvent of this kind is advantageously a solvent selected from the group consisting of acetone and cyclic ethers such as tetrahydrofuran (THF) or dioxane.

The coated and functionalized particles are present in the composition according to the invention advantageously in an amount of between from 0.01% to 70%, in particular from 0.05% to 60%, more particularly from 0.1% to 50%, and, very particularly, from 0.1% to 30% by weight, relative to the total weight of said composition.

By virtue of the nature of the coated and functionalized particles and of their behavior in a hydrophobic or partially hydrophobic solvent, the composition according to the invention is a composition which exhibits good dispersion (i.e., a homogeneous and stable dispersion) of said particles. It is appropriate to emphasize that the stability of the dispersion of the coated and functionalized particles of the invention that is obtained in this way in a hydrophobic or partially hydrophobic solvent such as a solvent based on methyl ethyl ketone or acetone is innovative.

The present invention ultimately produces a good (homogeneous and stable) dispersion of said coated and functionalized particles not only in a hydrophobic or partially hydrophobic solvent, but also in a polymer which is soluble in such a solvent. More specifically, the present invention involves producing a stable dispersion of particles, particularly particles of rare earth oxide or metal oxide which are of submicron or nanometric size, in a hydrophobic or partially hydrophobic solvent, such as a solvent based on methyl ethyl ketone and/or acetone, for the purpose of incorporating them homogeneously into the substance of a polymer which is soluble in such a solvent.

The present invention accordingly relates to a composition comprising at least one coated and functionalized particle as defined above in a hydrophobic or partially hydrophobic solvent as defined above and, furthermore, a polymer.

By “polymer” is meant, in the context of the present invention, a compound composed of a large number of low-mass repeating units which are obtained from the polymerization of identical or different monomers, which bond to one another, in the form of a chain or network, in order to create, respectively, homopolymers or copolymers (or heteropolymers) of high molecular mass.

The polymer is advantageously a polymer which is soluble in the hydrophobic or partially hydrophobic solvents as listed above. By “polymer soluble in a hydrophobic or partially hydrophobic solvent” is meant, in the context of the present invention, a polymer which is completely dissolved at a concentration greater than or equal to 5% by weight and at ambient temperature in a hydrophobic or partially hydrophobic solvent. Any polymer soluble in a hydrophobic or partially hydrophobic solvent can be used in the context of the present invention. These polymers are advantageously prepared from monomers which are hydrophobic in nature, or contain primarily such monomers. The monomers having a hydrophobic nature include the following:
styrenic derived monomers such as styrene, α-methylstyrene, para-methylstyrene or para-tert-butylstyrene,
esters of acrylic acid or methacrylic acid with C1-C12, preferably C1-C8, alcohols, optionally fluorinated, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate,
vinyl nitriles containing from 3 to 12 carbon atoms, and especially acrylonitrile or methacrylonitrile,
vinyl esters of carboxylic acids, such as vinyl acetate, vinyl versatate or vinyl propionate,
vinyl halides, an example being vinyl chloride, and
diene monomers, an example being butadiene or isoprene.

The polymer employed in the context of the present invention is more particularly a thermosetting polymer.

Nonlimitative examples of thermosetting polymers include aminoplasts (urea-formaldehyde resins), polyurethanes, unsaturated polyesters, phenoplasts (phenol-formaldehyde resins), polysiloxanes, epoxy resins, allyl resins and vinyl ester resins, alkyds (glycerophthalic resins), polyureas, polyisocyanurates, poly(bismaleimide)s, and polybenzimidazoles.

The polymer in the composition comprising at least one coated and functionalized particle according to the present invention may take different forms. Advantageously it takes the form of a varnish, a film, a resin, a coating or a paint.

The present invention further relates to a substrate coated with a composition comprising at least one coated and functionalized particle as defined above. The definition given above of the term “coated”, applied to the core of the particles according to the invention, also applies here to the substrate, mutatis mutandis.

The substrate employed in the context of the present invention may be any substrate which is known to the one skilled in the art and on which a composition of the invention may be applied, coated or grafted. The substrate may have any desired shape and any desired size. The substrate, or at least its surface, may consist of any desired natural or synthetic material. The material making up the substrate or its surface is advantageously selected from woven or nonwoven fabric, plastic, wood, metal, polymeric materials, and oxides.

The present invention relates, finally, to a method for preparing a coated and functionalized particle according to the present invention, comprising a step of contacting a particle comprising a silica-coated core (i.e., silica-coated particle) with a coupling agent comprising at least one chemical function soluble in a hydrophobic solvent, said coupling agent and the chemical function of said coupling agent being as defined above. The method for preparing a coated and functionalized particle according to the present invention comprises the following steps:
a) preparing a silica-coated particle;
b) preparing a solution comprising at least one coupling agent comprising at least one chemical function soluble in a hydrophobic solvent;
c) contacting the silica-coated particle obtained in step (a) with the solution prepared in step (b) to give at least one coated and functionalized particle.

It is appropriate to observe that, in the method of the invention, steps (a) and (b) are not necessarily steps which are carried out in succession. Indeed, step (a) may be implemented before, after or during step (b).

The particle employed in step (a) of the method comprises a core as defined above, i.e., a core composed of a metal, an organic compound or oxide, and, more particularly, of an oxide selected from metal oxides, rare earth oxides, and mixtures thereof.

Step (a) involves coating such a particle with a silica layer. The one skilled in the art knows of different techniques which allow submicron or nanometric particles to be coated with silica. Nonlimitative examples include the following:
coating particles of rare earth oxide such as gadolinium oxide with a silica layer especially by the sol-gel method, described by Louis et al. (2005) or by Bridot et al. (2007), for example;
coating, with a silica layer, particles of metal oxides such as alumina (Wang et al., 2005); of iron oxides, especially by combination of convective self-assembly and the sol-gel technique (Yuan et al., 2007), by a surfactant-assisted aerosol procedure (Zheng et al., 2007), or by a micelle route (Tsang et al., 2006); of titanium oxides by vapor-phase chemical deposition (Liu and Jiang, 2006), or of zinc oxides in particular by a sol-gel route (Ntwaeaborwa and Holloway, 2005).

Step (a) is advantageously a coating procedure carried out by the sol-gel method. In this variant, step (a) comprises the following substeps:
i) preparing a solution containing at least one particle;
ii) preparing a solution containing at least one silane-based compound;
iii) mixing the solution obtained in step (i) with the solution obtained in step (ii) to give at least one silica-coated particle.

The solution of step (i) may be any solution known to the skilled person, in which particles, particularly oxide particles, may be placed in solution. The solution employed in step (i) is advantageously a solution based on alcohol, and particularly on anhydrous ethanol, or any other anhydrous solvent which is miscible in ethanol. The particles are present in the solution employed in step (i) in a proportion of between 0.1% and 50%, in particular between 0.5% and 10%, and more particularly between 1% and 5% by mass, relative to the total mass of the solution. Moreover, in order to facilitate the dispersion of the particles in the solution employed in step (i), the latter may be stirred using a stirrer, a magnetic bar, an ultrasound bath or a homogenizer. Step (i) may be implemented at a temperature of between 10 and 40° C., advantageously between 20 and 30° C., and more particularly at ambient temperature, for a time of between 1 and 45 min, in particular between 5 and 30 min, and more particularly for 10 min.

Step (ii) involves preparing a solution comprising the compound which, following reaction with the particle, especially oxide particle, will give the silica layer coating said particle. The compound employed in this step (ii) is a silane-based compound. Said silane-based compound is advantageously an alkylsilane or an alkoxysilane of general formula SiR₁R₂R₃R₄, where R₁, R₂, R₃, and R₄, independently of one another, are H, a linear or branched alkyl group of 1 to 12 carbons, in particular of 1 to 6 carbon atoms, a linear or branched aryl group of 4 to 15 carbons, more particularly of 4 to 10 carbon atoms, or an alkoxy group of formula —OR₆ where R₃ represents an alkyl group as defined above. The silane-based compound is more particularly selected from tetraethoxysilane (TEOS, Si(OC₂H₅)₄). dimethylsilane (DMSi, Si(CH₃)₂H₂), phenyltriethoxysilane (PIES, C₆H₅Si (OC₂H₅)₃) , and dimethyldimethoxysilane (DMDMOS, Si(CH₃)2(OCH₃)₂). More particularly, the silane-based compound is tetraethoxysilane (TEOS, Si (OC₂H₅)₄). The solution employed in step (ii) is a solution based on alcohol and especially on ethanol. The silane-based compound is present in the solution employed in step (ii) in a proportion of between 1% and 80%, in particular between 5% and 60%, and more particularly between 10% and 40% by volume, relative to the total volume of the solution. Step (ii) may be implemented at a temperature of between 10 and 40° C., advantageously between 20 and 30° C., and, more particularly, at ambient temperature, for a time of between 1 and 45 min, in particular between 5 and 30 min, and more particularly for 10 min.

Step (iii) involves mixing the solutions prepared respectively in steps (i) and (ii). Beforehand, prior to mixing with the solution prepared in step (ii), it may be necessary to heat the solution prepared in step (i) so that its temperature is between 40 and 90° C., in particular between 50 and 80° C., and more particularly of the order of 70° C. (i.e., 70° C.±5° C.). It may also be advantageous to adjust the pH of the solution prepared in step (i) in order to give a pH of between 9 and 13, particularly 10 and 12, and, more particularly, of the order of 11 (i.e., 11±0.5). This adjustment to the pH may be carried out by addition of an appropriate amount, depending on each individual case, of a base such as sodium hydroxide, potassium hydroxide or ammonia, or of an acid such as hydrochloric acid. Mixing between the solution of step (i) and the solution of step (ii) is carried out, during step (iii), with stirring using a stirrer, a magnetic bar, an ultrasound bath or a homogenizer. In one variant of the present invention, the mixing of step (iii) is carried out by pouring the solution prepared in step (ii) dropwise into the solution prepared in step (i), its pH and its temperature having been adjusted where appropriate. During the mixing of step (iii), the proportions of solution prepared in step (ii)/solution prepared in step (i), expressed by volume, are between 1/50 and 1/400, in particular between 1/100 and 1/300, and more particularly 1/200. The mixture obtained in step (iii) is left with stirring using a stirrer, a magnetic bar, an ultrasound bath or a homogenizer, and at a temperature of between 40 and 90° C., in particular between 50 and 80° C., and more particularly of the order of 70° C. (i.e., 70° C.±5° C.), for a time of between 1 and 36 h, in particular between 5 and 24 h, and more particularly for 14 h.

Step (b) of the method according to the invention involves preparing a solution comprising at least one coupling agent comprising at least one chemical function soluble in a hydrophobic solvent. Said coupling agent and said chemical function are as defined above. The solution used in step (b) is advantageously a hydrophobic or partially hydrophobic solvent as defined above. During the mixing of step (b), the proportions of coupling agent/solution prepared in step (b), expressed by volume, are between 1/1000 and 1/10, in particular between 5/1000 and 5/100, more particularly between 1/100 and 2/100, and, very particularly, 1.5/100. The mixing obtained in step (b) is carried out with stirring using a stirrer, a magnetic bar, an ultrasound bath or a homogenizer, and at a temperature of between 10 and 40° C., advantageously between 20 and 30° C., and more particularly at ambient temperature, for a time of between 1 and 48 h, in particular between 12 and 36 h, and more particularly for 24 h.

Step (c) of the method according to the invention involves contacting the silica-coated particle obtained in step (a) with the solution prepared in step (b) , to give at least one coated and functionalized particle. Prior to said contacting, the silica-coated particle is placed in suspension in a hydrophobic or partially hydrophobic solvent, particularly if it has been prepared in a hydrophilic solvent in step (a), which is the case in the event of the sol-gel method. The one skilled in the art knows various techniques comprising steps of dilution and/or of centrifugation to resuspend said particle in a hydrophobic or partially hydrophobic solvent as defined above. The silica-coated particle is advantageously present in said hydrophobic or partially hydrophobic solvent at a concentration of between 0.1% and 50%, in particular between 0.5% and 10%, and more particularly between 1% and 5% by mass, relative to the total mass of the solvent.

Consequently, step (c) of the method according to the present invention involves mixing the hydrophobic or partially hydrophobic solvent containing at least one silica-coated particle with the solution prepared in step (b). At the mixing stage of step (c), the proportions (hydrophobic or partially hydrophobic solvent containing at least one silica-coated particle)/(solution prepared in step (b)), expressed by volume, are between 1/5 and 5/1, in particular between 1/2 and 2/1, and more particularly 1/1. The mixing obtained in step (c) is carried out with stirring using a stirrer, a magnetic bar, an ultrasound bath or a homogenizer and at a temperature of between 10 and 40° C., advantageously between 20 and 30° C., and, more particularly, at ambient temperature for a time of between 1 min and 24 h, in particular between 15 min and 10 h, and more particularly for 30 min.

The present invention likewise relates to a method for preparing a composition as defined above, comprising the following steps:
a′) preparing a solution containing at least one coated and functionalized particle prepared by a method as defined above,
b′) preparing a hydrophobic or partially hydrophobic solution optionally containing at least one monomer and/or at least one polymer,
c′) mixing the solution prepared in step (a′) with the solution prepared in step (b′) to give a composition as defined above.

At the mixing stage of step (c′), the proportions (solution prepared in step (a′))/(solution prepared in step (b′)), expressed by volume, are between 1/5 and 5/1, in particular between 1/2 and 2/1, and more particularly 1/1. The mixing obtained in step (c′) is carried out with stirring using a stirrer, a magnetic bar, an ultrasound bath or a homogenizer and at a temperature of between 10 and 40° C., advantageously between 20 and 30° C., and more particularly at ambient temperature.

In a first variant of the method for preparing a composition according to the present invention, the hydrophobic or partially hydrophobic solution prepared in step (b′) contains neither monomer nor polymer. The hydrophobic or partially hydrophobic solution employed is a solution based on any hydrophobic or partially hydrophobic solvent as defined above. Said method, in this variant, produces a composition comprising at least one coated and functionalized particle in a hydrophobic or partially hydrophobic solvent. In this variant, step (c′) of the method according to the invention lasts between 1 min and 45 min, in particular between 2 and 15 min, and more particularly for 5 min.

In a second variant of the method for preparing a composition according to the present invention, the hydrophobic or partially hydrophobic solution prepared in step (b′) contains at least one monomer. The monomer present is advantageously a hydrophobic monomer as defined above. Step (c′) in this variant therefore comprises the polymerization of the various, identical or different, hydrophobic monomers that are present in the solution prepared in step (b′), in the presence of the coated and functionalized particles prepared in step (a′). This polymerization is selected in particular from an anionic or cationic free-radical polymerization, a polycondensation, a copolymerization/copolycondensation, carried out thermally, photochemically or radiochemically, and in emulsion, in suspension or by precipitation. In this variant, step (c′) of the method lasts between 5 min and 5 h, in particular between 10 min and 2 h, more particularly between 30 min and 1 h.

In a third variant of the method according to the present invention, the hydrophobic or partially hydrophobic solution prepared in step (b′) contains at least one polymer. The polymer or polymer mixture present is advantageously a polymer or a mixture of polymers as defined above. In this third variant, step (c′) of the method according to the invention lasts between 1 min and 45 min, in particular between 2 and 15 min, and more particularly for 5 min.

In a last variant of the method according to the present invention, the hydrophobic or partially hydrophobic solution prepared in step (b′) contains at least one monomer and at least one polymer. The particular features of the two preceding variants therefore apply here.

In the four variants of the method according to the present invention, the composition obtained is a stable and homogeneous dispersion of coated and functionalized particles according to the present invention either in a hydrophobic or partially hydrophobic solvent or in a polymer. As already explained, the stability of the dispersion of all of these particles, therefore, in a hydrophobic or partially hydrophobic solvent based in particular on methyl ethyl ketone and/or on acetone, then in a polymer which is advantageously soluble in this type of solvent, is innovative.

The present invention relates, lastly, to the use of a particle as defined above and/or of a composition as defined above for the traceability marking of an object. Indeed, the present invention produces an effective and homogeneous dispersion of all types of coated and functionalized particles, particularly those based on oxide, with submicrometric or nanometric sizes, in a hydrophobic solvent or partially hydrophobic solvent, then in a polymer such as a thermosetting polymer of the varnish type or other type. The resulting varnish may be applied or coated onto any desired object, and in particular onto fabrics or onto rigid substrates (polymeric or metallic materials, oxides, etc.) which may be natural or synthetic. The coated and functionalized oxide particles that are the subject matter of the present invention, introduced into a polymer to be coated onto any type of substrates, make it possible, by virtue of their properties, to impart properties of luminescence or magnetic properties to the coated material. Similarly, for the solid thermosetting polymer, the particles incorporated into the substance of the polymeric material allow its properties to be modified in the same way.

The present invention relates to the use of a particle as defined above for modifying the physicochemical properties of a polymer. In this application, the coated and functionalized particles according to the present invention, when dispersed into a polymer as defined above, modify its physicochemical properties. Said physicochemical properties are selected from properties of flame retardancy, thermal conduction, electrical conduction, and mechanical, optical, and magnetic properties. For example, for flame retardancy properties, antimony oxide particles are used advantageously. The dispersion of other types of oxide (aluminum oxide, rare earth oxide, etc.) may also be used to modify the properties of the varnish or of the polymer: thermal conduction, electrical conduction, mechanical properties, etc.

Other characteristics and advantages of the present invention will additionally be apparent to the one skilled in the art on reading the examples below, which are given as an illustration and not a limitation, with reference to the attached figures.

### BRIEF DESCRIPTION OF THE DRAWINGS

FIG. 1 is a photograph of a coating of varnish on fabrics, containing a dispersion of luminescent particles (doped rare earth oxide) which has not undergone the coating and functionalization protocol according to the present invention. The photo is taken under UV excitation (254 nm) for visualization of the luminescence of the particles. The dots A correspond to agglomerates of rare earth oxide particles, distributed inhomogeneously in the varnish which has not undergone the coating and functionalization treatment according to the invention.

FIG. 2 is a photograph of a coating of varnish on fabrics, containing a dispersion of luminescent particles (doped rare earth oxide) which has undergone the coating and functionalization protocol according to the present invention. The photo is taken under UV excitation for visualization of the luminescence of the particles. The regions B and C correspond respectively to the area of uncoated fabric and the area of the coating of varnish with silica-coated rare earth oxide particles functionalized with a coupling agent.

### DETAILED DESCRIPTION OF PARTICULAR EMBODIMENTS

### Example 1 (Comparative)

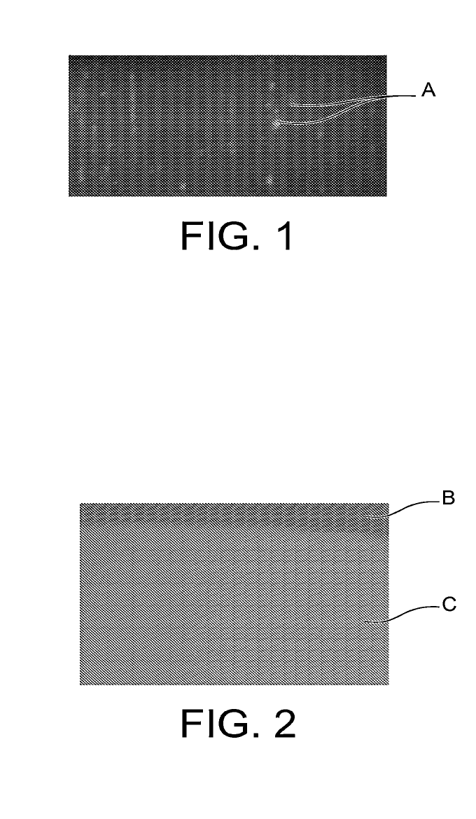

The following protocol was followed:
dissolution of submicron particles of luminescent rare earth oxide or metal oxides in acetone (or methyl ethyl ketone). The particle concentration is 2% by mass. The mixture is dispersed using a Turrax homogenizer, to form solution A′, for 5 minutes at medium stirring power;
preparation of a solution B′, by mixing solution A′ and the coating varnish, to give a particle concentration in the varnish of 0.1% by mass. This solution is mixed using a Turrax homogenizer for 5 minutes at medium power;
the varnish is then applied to the textile by coating (FIG. 1).

### Example 2

### Preparation of a Varnish Based on Polymethyl Acrylate and Polyvinyl Chloride, Containing Coated and Functionalized Particles According to the Invention

The following protocol was followed:
dissolution of submicron particles of luminescent rare earth oxide or metal oxides in anhydrous ethanol. The particle concentration is 2% by mass. The mixture is dispersed using a Turrax homogenizer, to form solution A, for 5 minutes at medium stirring power. The volume of this solution is 60 ml;
preparation of a solution containing 20% by volume of tetraethoxysilane (TEOS) in ethanol, to form solution B;
solution A is continuously stirred under the action of a magnetic stirrer and heated at 70° C. The pH of the solution is checked by addition of the appropriate amount of ammonia, to make it approximately 11 (a few drops). 300 μl of solution B are then introduced dropwise into solution A;
the resulting mixture is left with homogenization (by magnetic stirring) and heating at 60° C. for 14 h;
an excess of acetone (approximately 40 ml) is added to the reaction mixture;
three washes are carried out with acetone, using a centrifuge;
the powders recovered are redissolved in acetone, to give solution C; the target concentration is 2% by mass of particles;
a solution is prepared by mixing 150 μl of hexadecyltrimethoxysilane into 10 ml of MEK (methyl ethyl ketone), with magnetic stirring over 24 hours, to form solution D;
10 ml of solution C are then added to solution D.

The resulting solutions C and D are stable.

All that is now needed is to mix 10 ml of the particles/MEK mixture into 10 ml of varnish, using the Turrax homogenizer at medium power for 5 minutes, to give a stable dispersion of particles in the varnish. The varnish is then coated onto a textile to give a homogeneous dispersion of fluorescent particles which are called markers (FIG. 2). The constituent polymer of the varnish is a mixture in equal proportions of polymethyl acrylate and polyvinyl chloride in a MEK solvent.

### Example 3

### Preparation of a Polymethyl Methacrylate (PMMA)-Based Polymer Containing Coated and Functionalized Particles According to the Invention

A second protocol was also trialed.

Starting from the aforementioned solution D, the authors mixed 4 g of PMMA into 20 ml of chloroform and 5 ml of solution D. The resulting solution is stirred with an ultrasound bath for 10 minutes. This gave, after evaporation, a polymer containing nanofillers.

### BIBLIOGRAPHIC REFERENCES

Wetzel, B.; Haupert, F.; Zhang, M. Q.; Composites Science and Technology, 2003, 63, 2055-2067.

Chen, G.; Zhou, S.; Gu, G.; Wu, L.; Colloids and Surfaces A : Physicochem. Eng. Aspects, 2007, 296, 29-36.

Oberdisse, J.; Soft Matter, 2006, 2, 29-36.

Goubard, F.; Vidal, F.; Bazzi, R.; Tillement, O.; Chevrot, C.; Teyssié, D.; Journal of Luminescence, 2007, 126, 289-296.

Bagwe, R. P.; Hilliard, L. R.; Tan, W.; Langmuir, 2004, 22, 4357-4362.

Chen, Su; Sui, Jianjun; Chen, Li; Pojman, John A.; Journal of Polymer Science, Part A: Polymer Chemistry, 2005, 43(8), 1670-1680.

Chalaye, Sandrine; Bourgeat-Lami, Elodie; Putaux, Jean-Luc; Lang, Jacques; Macromolecular Symposia, 2001, 169(Fillers and Filled Polymers), 89-96.

Feng, Cang; Chen, Su; Chen, Li; Abstracts of Papers, 230th ACS National Meeting, Washington, D.C., United States, 2005.

Iijima, M.; Tsudaka, M.; Kamiya, H.; Journal of Colloid and Interface Science, 2007, 307, 418-424.

Patent application US 2007/0104860 (Gleason, Karen K.; Lau, Kenneth K. S.) published May 10, 2007.

International application WO 2007/068859 (Braconnot, Sebastien; Elaissari, Abdelhamid; Mouaziz, Hanna) published Jun. 21, 2007.

International application WO 2005/037470 (Lark, John C.) published April 28, 2005.

Louis, C.; Bazzi, R.; Marquette, C.; Bidot, J.; Roux, S.; Ledoux, G.; Mercier, B.; Blum, L.; Perriat, P.; Tillement, O.; Chemistery of Materials, 2005, 17, 1673-1682.

Bridot, J.-L.; Faure, A.-C.; Laurent, S.; Riviere, C.; Billotey, C.; Hiba, B.; Janier, M.; Josserand, V.; Coll, J.-L.; Vander Elst, L.; Muller, R.; Roux, S.; Perriat, P.; Tillement, O.; Journal of the American Chemical Society, 2007, 129(16), 5076-5084.

Wang, S.; Hsu, Y.; Yang, T.; Chang, C.; Chen, Y.; Huang, C.; Yen, F.; Materials Science and Engineering A, 2005, 395, 148-152.

Yuan, Zhen; Petsev, Dimiter N.; Prevo, Brian G. ; Velev, Orlin D.; Atanassov, Plamen; Langmuir, 2007, 23(10), 5498-5504.

Zheng, Tonghua; Pang, Jiebin; Tan, Grace; He, Jibao; McPherson, Gary L.; Lu, Yunfeng; John, Vijay T.; Zhan, Jingjing; Langmuir, 2007, 23(9), 5143-5147.

Tsang, Shik Chi; Yu, Chih Hao; Gao, Xin; Tam, Kin; Journal of Physical Chemistry B, 2006, 110(34), 16914-16922.

Liu, Yan; Jiang, Hong; Electroanalysis, 2006, 18(10), 1007-1013.

Ntwaeaborwa, O. M.; Holloway, P. H. ; Nanotechnology, 2005, 16(6), 865-868.

1-16. (canceled)

17. A method for traceability marking of an object comprising:
a step of applying to said object at least one particle or a composition comprising at least one particle in a hydrophobic or partially hydrophobic solvent,
wherein said particle comprises
a core composed of an element selected from the group consisting of oxides of at least one rare earth metal, wherein said rare earth metal is selected from the group consisting of lanthanum, praseodymium, neodymium, promethium, samarium, europium, gadolinium, terbium, dysprosium, holmium, erbium, thulium, ytterbium, and lutetium, oxides of yttrium, oxides of scandium, yttrium aluminum garnet (YAG), yttrium aluminum oxide (YAlO), and vanadated yttrium oxide, and mixtures thereof,
said core being coated with a layer of silica functionalized with a coupling agent comprising at least one chemical function soluble in a hydrophobic solvent.

18. The method according to claim 17, wherein said chemical function contains from 6 to 50 carbon atoms.

19. The method according to claim 17, wherein said chemical function is selected from the group consisting of
C6 to C50 linear or branched alkyls possibly containing optionally at least one unsaturation and/or at least one heteroatom,
C6 to C50 alkylaryls or arylalkyls possibly containing optionally at least one unsaturation and/or at least one heteroatom, and
C6 to C50 (poly)cyclics possibly containing optionally at least one unsaturation and/or at least one heteroatom.

20. The method according to claim 17, wherein said coupling agent is hexadecyltrimethoxysilane.

21. The method according to claim 17, wherein said core additionally comprises a metal oxide material different from said element.

22. The method according to claim 17, wherein said composition further comprises at least one polymer.

23. The method according to claim 22, wherein said polymer is a thermosetting polymer.

24. The method according to claim 22, wherein said polymer takes the form of a varnish, a film, a resin, a coating or a paint.

25. The method according to claim 23, wherein said polymer takes the form of a varnish, a film, a resin, a coating or a paint.
